(19) United States
(12) Patent Application Publication
(10) Pub. No.: US 2024/0152411 A1
(43) Pub. Date: May 9, 2024

(54) SECURE, COLLABORATIVE, DIGITAL CLIPBOARD

(71) Applicant: Switchboard Visual Technologies, Inc., San Jose, CA (US)

(72) Inventors: Chris Jones, San Bruno, CA (US); Neil Rotstan, Winthrop, WA (US)

(21) Appl. No.: 17/980,020

(22) Filed: Nov. 3, 2022

(51) Int. Cl. G06F 9/54

(52) U.S. Cl. CPC G06F 9/543

(57) ABSTRACT

Systems and methods for secure, collaborative, digital clipboards are provided. A method may include allocating one or more clipboard seats that are mapped to one or more of a plurality of user devices. The user devices may each be accessing a shared digital application in a collaborative digital workspace that is configured to cause an action executed to the shared digital application on one of the user devices to generalize for all the user devices. The method may include launching a shared digital clipboard that may be configured to be used by the plurality of user devices to copy and paste information in the collaborative digital workspace. The shared digital clipboard may also be configured to maintain a private copy-and-paste environment for each clipboard seat, wherein information copied to the clipboard by an entity mapped to a clipboard seat is inaccessible to any entity that is unmapped to that clipboard seat. The method may also include assigning an active state to one of the clipboard seats in response to a predetermined trigger event, and executing copy and/or paste actions in the collaborative digital workspace exclusively for an entity mapped to the clipboard seat with the active state.

### FIELD OF TECHNOLOGY

Aspects of the disclosure relate to digital systems. Specifically, aspects of the disclosure relate to digital clipboard systems.

### BACKGROUND OF THE DISCLOSURE

The digital clipboard feature of modern window managers is an essential tool for transferring data between applications and documents via copy, cut, and paste actions. However, conventional digital clipboards were designed for fundamentally single-user environments. Using a single-user clipboard in a multi-user environment presents functionality challenges as well as security concerns.

For example, some embodiments of multi-user collaboration environments expose a clipboard-like feature. However, the clipboards provided are typically single-user clipboards applied in a multi-user environment. Accordingly, such shared clipboards tend to be unpredictable to use because it can be unclear which user can supply or access the contents of the clipboard. Worse, a shared clipboard opens numerous attack vectors for unexpected exfiltration of private data from collaborators or others. For example, User A might copy a password through a shared clipboard in order to log into a site, but A's collaborator User B might exfiltrate A's password without the knowledge of A.

Furthermore, modern windowing environments may also allow programmatic access to the clipboard, in which third-party machine code can read from and write to the clipboard. Programmatic clipboard access creates yet another source of confusion and vector for exfiltration attacks.

It would be desirable, therefore, to provide systems and methods for a digital clipboard that maintains security and functionality in a collaborative, multi-user, environment.

### SUMMARY OF THE DISCLOSURE

Aspects of the disclosure relate to systems and methods for a secure, collaborative, digital clipboard. A system may be configured to allocate one or more clipboard seats. Each clipboard seat may be mapped to one or more of a plurality of user devices. The user devices may each be accessing a shared digital application in a collaborative digital workspace. The collaborative digital workspace may be configured to cause an action executed to the shared digital application on one of the user devices to generalize for all the user devices.

The system may be configured to launch a shared digital clipboard. The shared digital clipboard may be configured to be used by the plurality of user devices to copy and paste information in the collaborative digital workspace. The shared digital clipboard may also be configured to maintain a private copy-and-paste environment for each clipboard seat. In the private environment, information copied to the clipboard by an entity mapped to a clipboard seat may be inaccessible to any entity that is unmapped to that clipboard seat.

The system may be configured to assign an active state to one of the clipboard seats in response to a predetermined trigger event. The system may be configured to execute copy and/or paste actions in the collaborative digital workspace exclusively for an entity mapped to the clipboard seat with the active state.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative apparatus in accordance with principles of the disclosure;

FIG. 3 shows an illustrative diagram in accordance with principles of the disclosure;

FIG. 4 shows another illustrative diagram in accordance with principles of the disclosure; and

FIG. 5 shows another illustrative diagram in accordance with principles of the disclosure.

### DETAILED DESCRIPTION OF THE DISCLOSURE

Aspects of the disclosure relate to systems and methods for a secure, collaborative, digital clipboard. A system may include computer executable code stored in a non-transitory memory that, when run on a processor, may be configured to execute system functions and/or execute method steps. Some or all system configurations disclosed herein may correlate with steps of the methods.

A system may be configured to allocate one or more clipboard seats. Each clipboard seat may be mapped to one or more of a plurality of user devices. The user devices may each be accessing a shared digital application in a collaborative digital workspace. The digital application may be a computer program or other suitable digital resource. The collaborative digital workspace may be configured to cause an action executed to the shared digital application on one of the user devices to generalize for all the user devices.

In some embodiments collaborative workspaces may include remote collaborative environments. In a remote collaborative environment, multiple users on different machines may be accessing and/or collaborating on a shared digital resource. Illustrative remote collaborative environments include systems and methods described in commonly-assigned U.S. Pat. Nos. 11,349,889 and 11,314,474, the contents of which are hereby incorporated by reference in their entireties.

In certain embodiments, collaborative workspaces may also include local environments in which multiple users on the same machine are accessing and/or collaborating on a shared digital resource. For example, the multiple users may each be using a separate input device (e.g., a keyboard and/or mouse) that are all connected to the same computing device.

The system may be configured to launch a shared digital clipboard. The shared digital clipboard may be configured to be used by the plurality of user devices to copy and paste information in the collaborative digital workspace. The shared digital clipboard may also be configured to maintain a private copy-and-paste environment for each clipboard seat. In the private copy-and-paste environment, information copied to the clipboard by an entity mapped to a clipboard seat may be inaccessible to any entity that is unmapped to that clipboard seat. The entity may be a user device. In certain embodiments, the entity may also be a computer program configured to access the clipboard.

The system may be configured to assign an active state to one of the clipboard seats in response to a predetermined trigger event. The system may be configured to execute copy and/or paste actions in the collaborative digital workspace exclusively for an entity mapped to the clipboard seat with the active state. Copy and/or paste actions may include copying information to the clipboard. “Copying” may, in some embodiments, include a “cutting” action, which may be a combined copy and delete action. Copy and/or paste actions may include accessing information from the clipboard. Copy and/or paste actions may include pasting information from the clipboard to another location. In some embodiments, copy and/or paste actions may include selecting or highlighting information.

The system may be configured with a policy for how to respond when an inactive user performs copy and/or paste actions. In some embodiments, the system may ignore copy and/or paste actions performed by inactive users. In some embodiments, the system may store the actions and implement them when the inactive user becomes active. In some embodiments, the system may allow an inactive user to copy information to their seat context of the clipboard, but the inactive user may only be allowed to retrieve information from the clipboard (e.g., to paste it) when they are in an active state.

In some embodiments, multiple seats can be active simultaneously. This may allow each active user to perform copy and/or paste actions in their separate private environments in which information is not accessible between seats. For example, User A may be able to copy his credit card information to his clipboard seat, and User B may be able to copy her private password to her clipboard seat. Subsequently, User B may paste her password but not User A's credit card information, and User A may paste his credit card information but not User B's password.

The system may notify the inactive user of their inactive state and/or the ramifications of the inactive state (e.g., “copy actions are currently disabled” or “your copy action will be applied when you are activated”). The notification may, in some embodiments, be shown in response to the actions. In other embodiments, an indicator may be displayed to all the active and/or inactive users of the collaborative environment indicating their active/inactive state.

Some embodiments may be further configured to allocate a plurality of clipboard seats corresponding to the plurality of user devices. Each of the plurality of clipboard seats may be mapped to a corresponding one of the plurality of user devices.

In certain embodiments, the shared digital application may be a first shared digital application, the collaborative digital workspace may be a first collaborative digital workspace, and the active state may be a first active state. The user devices may each also be accessing a second shared digital application in a second collaborative digital workspace. Each collaborative digital workspace may occupy one device window. The system may be further configured to assign a second active state to another one of the clipboard seats in response to another predetermined trigger event. The system may also be configured to execute copy and paste actions in the second collaborative digital workspace exclusively for an entity mapped to the clipboard seat with the second active state. Thus each window and/or collaborative digital workspace may be associated with its own collaborative clipboard.

Some embodiments may be further configured to allocate a machine clipboard seat. The machine clipboard seat may be a clipboard seat that is mapped to a computer program. The program may be configured to access a digital clipboard without user intervention. The system may be configured to provide a private copy-and-paste environment for the computer program.

Some embodiments may be further configured to receive copy and/or paste actions from an entity mapped to the clipboard seat with the active state. The system may translate the copy and/or paste actions into instructions for a single-user digital clipboard. The system may transmit the instructions to a native single-user digital clipboard on one or more of the user devices to synchronize the native single-user digital clipboard with the shared digital clipboard.

In some embodiments, the native single-user digital clipboard may be synchronized with the shared digital clipboard in response to a copy or paste action received from an entity mapped to the clipboard seat with the active state. In other embodiments, the native single-user digital clipboard may be continuously synchronized with the shared digital clipboard.

In certain embodiments, the predetermined trigger event may include an event that activates a focus of a window associated with the shared digital application and/or the collaborative digital workspace of an entity. The clipboard seat mapped to that entity may be the one assigned the active state.

In some embodiments, the predetermined trigger event may include a detection of user activity associated with an entity. The clipboard seat mapped to that entity may be the one assigned the active state. The user activity may be from a list that includes mouse pointer events, keyboard events, and/or touchscreen events. Mouse pointer events may include a mouse click. Mouse pointer events may include a selection or highlighting action. Mouse pointer events may, in certain embodiments, also include detection of movement on a touchpad. Keyboard events may include typing. Touchscreen events may include detection of a user touching the touchscreen.

In certain embodiments, the predetermined trigger event may include a detection of a predetermined gesture performed by an entity. The clipboard seat mapped to that entity may be the one assigned the active state. The gesture may be from a list that includes cut gestures, copy gestures, and/or paste gestures. The gestures may include a combination of actions that are interpreted by the system as a cut, copy, and/or paste request. This may be system specific. For example, a CTRL C keyboard input with highlighted text present may, on a Windows™ system, be considered a copy gesture. A copy gesture may also include selection of an explicit “copy” option displayed on a screen of a device (e.g., after a right click on highlighted text).

In some embodiments, a clipboard controller may be displayed on some or all the user devices accessing the collaborative window. The controller may be a widget that allows a user (or, in an embodiment, an authorized subset of users) to select an active clipboard state. For example, the widget may be an icon (e.g., a clipboard shape) displayed at an edge of the collaborative workspace. Selection via the controller may, in certain embodiments, be the predetermined trigger event or one of the predetermined trigger events. Selection via the controller may, in certain embodiments, be selectable only when no other user is active. In some embodiments, the controller may indicate if it is selectable or not (e.g., by being green vs. red, standard vs. grayed-out, or any other suitable indicator).

In some embodiments, a first user's active state may terminate when a second user executes a trigger event. In certain embodiments, an active user may terminate their own active state when they execute a paste gesture. In some embodiments, an active user may select an option on the controller to relinquish the active state when they are done using the clipboard.

The system may implement a policy that governs the scenario when a second user executes a trigger event while a first user is active. In some embodiments, the trigger event may transfer active state from the first user to the second. In other embodiments, the trigger event of the second user may be ignored. In some embodiments, the trigger event of the second user may place the second user next in line for active status. For example, in certain embodiments multiple users may be able to execute trigger events, and the system may place those users in a queue. The system may grant active state sequentially to the users in the queue, one at a time (e.g., automatically or via an option presented to the next-in-line user).

Thus, a secure multi-user clipboard is described which preserves the essential function of copying and pasting data between apps and documents, but is also predictable and secure in a multi-user collaborative environment. The system operates by maintaining a “seat” context for each individual user in the collaborative environment. Each seat includes a clipboard context that's private to the user associated with the seat. A multi-user-aware window manager may then apply various policies to ensure that the copy, cut, and paste actions initiated by individual users: (i) behave predictably for each user, by reading and writing data only from the individual user's seat; (ii) are not vulnerable to data exfiltration by other users by virtue of separated seat contexts; and (iii) are less susceptible to data exfiltration via programmatic clipboard access by machine code.

There are a range of configurations that specific embodiments may implement. The configurations may implement certain policies that may reflect a level of trust placed in the embodiment's users, and the desired tradeoff between security and functionality. Some exemplary configurations, not all of which are mutually exclusive, include:
1) One seat, shared among all users in the multi-user collaborative environment. This embodiment of the invention may, in practice, function similarly to the traditional “shared clipboard” approach.
2) Seat-per-user, where only one seat may be active— i.e., enabled for clipboard operations—at any time. A range of sub-policies may be used to determine active/inactive status, including but not limited to: a) “Focus” of the window, input context, or collaborative environment by the user; b) Recent activity within the environment, for example pointer, keyboard, or touchscreen events; and/or c) Completion of a specific clipboard gesture by the user (cut, copy, paste).
3) Seat-per-user with an additional “system clipboard” context, in which user active state— as described above— determines which seat synchronizes contents with the system clipboard. This policy can be useful to apply in environments with legacy single-user applications. The collaborative clipboard may thus be an adapter that translates from the multi-user environment to the single-user environment. The system may be further configured to implement a range of sub-policies to govern how data is synchronized between the seat clipboard and the system clipboard. For example: a) Synchronization only occurs during explicit “paste” actions by users (which may provide added security); or b) Synchronization occurs for the entire duration that a seat is considered active (which provide added functionality).
4) Seat-per-user with an additional machine seat. This policy can be useful to apply in environments in which programmatic access to the clipboard is desired to be isolated from user clipboard actions.
5) Seat-per-user, where instead of a globally active seat among all windows, each individual window is allowed to have its own active seat. With this policy, a multi-user collaboration environment can enable multiple users to interact with different windows simultaneously— each with its own active seat— with little or no risk of disruption to the user experience.

For purposes of illustration, Appendix A is attached hereto and includes exemplary code listings for implementing various aspects of the disclosed invention. The code listings include:
Portion 1-Code illustrating the model of a “seat” that includes an isolated clipboard (i.e., the clipboard context associated with an individual seat—isolated clipboards can't directly read and write each other's contents);
Portion 2-Code illustrating the implementation of an isolated clipboard; and
Portion 3-Code illustrating the brokered dispatch of events with activation and authorization (i.e., the logic that takes as input an event to dispatch, figures out the origin and target of the event, ensures that the user (origin) has authorization to dispatch the event, activates any seats that the event may incidentally cause to be activated by the current policy, and then dispatches the event to its target for handling. In other words, this listing shows how the invention fits into the actual dispatching of events, using the model of the seats/isolated clipboards).

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

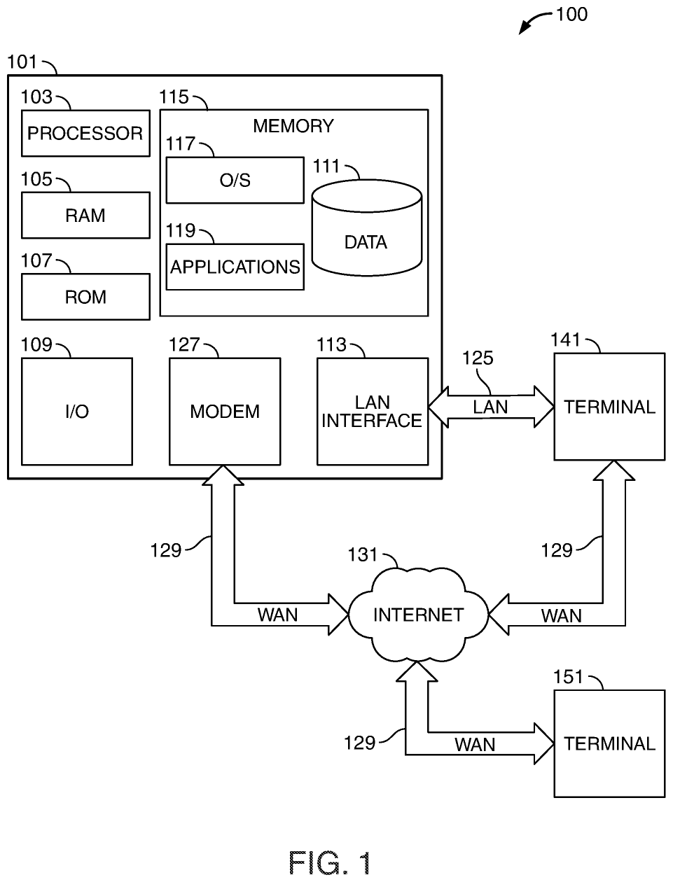

FIG. 1 shows an illustrative block diagram of system 100 that includes computer 101. Computer 101 may alternatively be referred to herein as a “server” or a “computing device.” Computer 101 may be a workstation, desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may comprise any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input may relate to digital clipboards. The input/output module may also include one or more speakers for providing audio output and a video display device for providing textual, audio, audiovisual, and/or graphical output. The input and output may be related to computer application functionality. The input and output may be related to digital clipboards.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related to performing various tasks. The various tasks may be related to digital clipboards.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry™, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

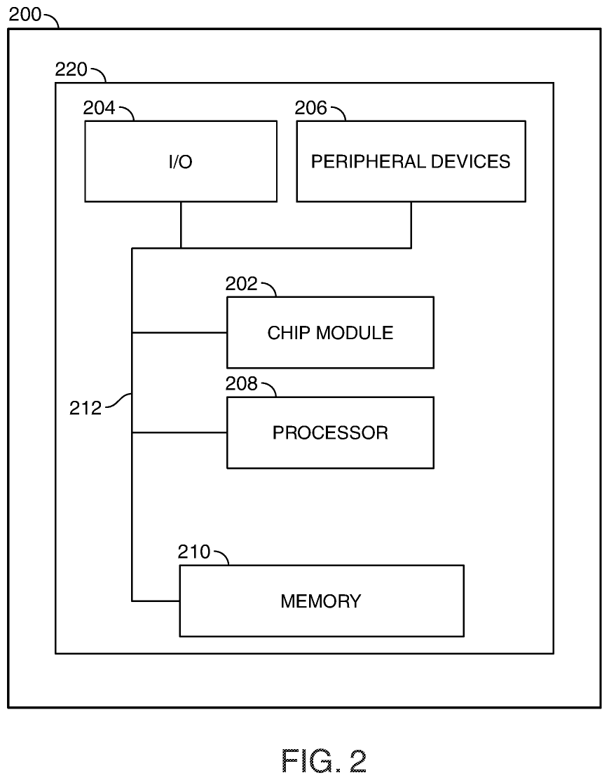

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

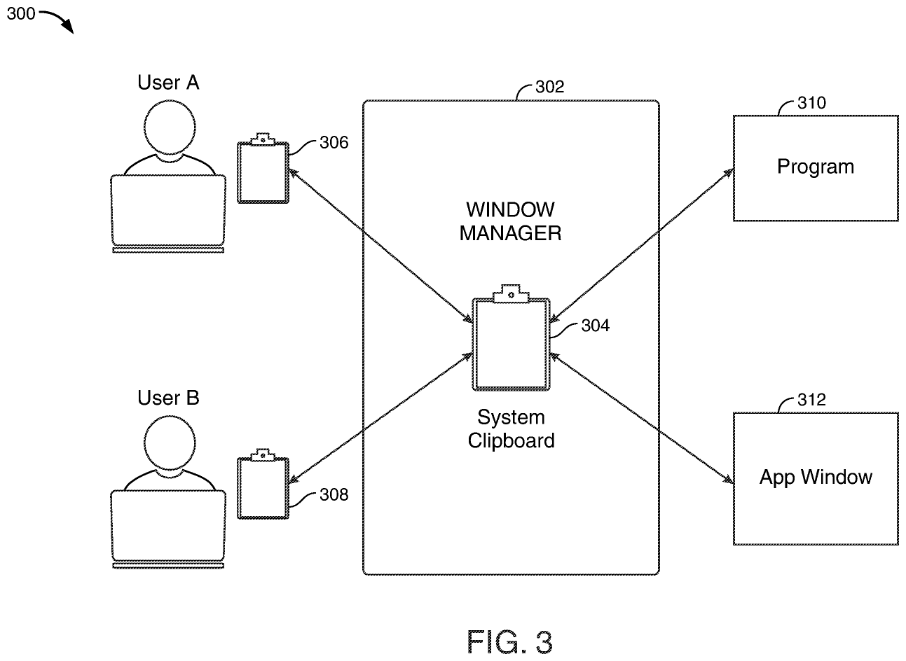

FIG. 3 shows diagram 300 of an illustrative digital clipboard system. The clipboard system shown in FIG. 3 may share similarities with conventional clipboard systems. The clipboard system in diagram 300 includes window manager 302 and a single shared system clipboard 304. System clipboard 304 may be implemented by, or in conjunction with, window manager 302. System clipboard 304 may be operable to execute cut, copy, and/or paste actions to app window 312. System clipboard 304 may feature programmatic access for program 310.

System clipboard 304 may be a digital clipboard designed for use with a single user. Diagram 300 shows a multi-user environment in which multiple users are accessing a shared digital resource (e.g., app window 312). User A has access to clipboard controls 306 which operate system clipboard 304, and User B has access to clipboard controls 308 which also operate system clipboard 304. When applying a single-user system clipboard in the multi-user environment of diagram 300, synchronization of User A's inputs and User B's inputs is often unclear. Furthermore, it is possible for clipboard data to accidentally leak between users and also to other programs (e.g., program 310), or be maliciously exfiltrated or implanted.

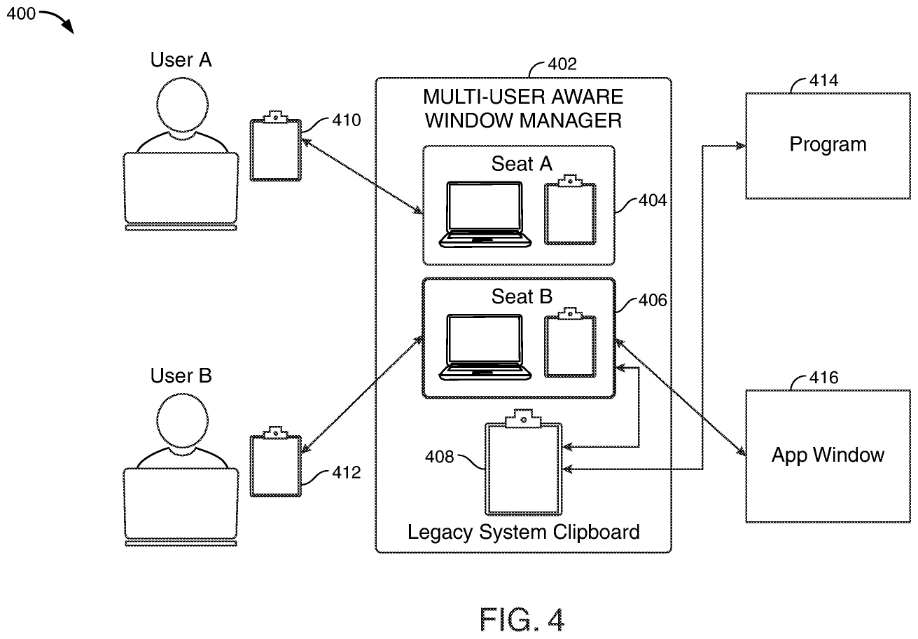

FIG. 4 shows diagram 400 of an illustrative secure, collaborative, digital clipboard system according to aspects of the disclosure. Diagram 400 shows window manager 402 which is configured for a multi-user environment in which multiple users are accessing a shared digital resource (e.g., app window 416). A shared clipboard may be implemented by, or in conjunction with, window manager 402. User A has access to clipboard controls 410 (e.g., on a first user device) which operate the shared clipboard, and User B has access to clipboard controls 412 (e.g., on a second user device) which also operate the shared clipboard.

The shared clipboard system is configured to coordinate inputs received from the multiple users and/or programs, and to maintain data privacy and security among the users and programs that may be accessing the clipboard. The system allocates a first seat context 404 corresponding to User A and a second seat context 406 corresponding to User B. Seat context 406 is shown with a bold outline to indicate that the seat context corresponding to User B is in an active state. Accordingly, an arrow is shown connecting seat context 406 to app window 416 to indicate that User B has exclusive ability to execute copy and/or paste actions to app window 416 via clipboard controls 412. Copy and/or paste actions initiated by inactive User A may be ignored by the system, or, in some embodiments, may be stored, or buffered, by the system and may be applied when User A becomes active. For example, the system may be configured to save data copied by an inactive user to their seat, but only execute a paste action for the data when the user is active.

Diagram 400 shows an embodiment of the collaborative shared browser configured to interface with legacy system clipboard 408 which may be a single-user clipboard. The shared clipboard may coordinate activity and data from the multi-user user environment and synchronize with legacy system clipboard 408. For example, in the scenario shown in diagram 400, the system may ignore copy/paste commands from inactive User A and transmit copy/paste commands from active User B to legacy system clipboard 408.

Diagram 400 shows an embodiment of the collaborative shared browser without a separate machine seat context. Thus, program 414 is shown with direct access to the clipboard system that does not rely on an active seat dedicated for programs. Other embodiments may implement a machine seat, which may provide a seat context for program 414 that is separate from the other seats.

Thus, diagram 400 shows an example embodiment of the Secure Multi-user Clipboard invention with the following configuration choices: (i) seat-per-user; (ii) legacy system clipboard syncing from active seat; (iii) no isolated machine seat; and (iv) one globally active seat instead of active-seat-per-window. In the example of diagram 400, the seat of User B is shown as active.

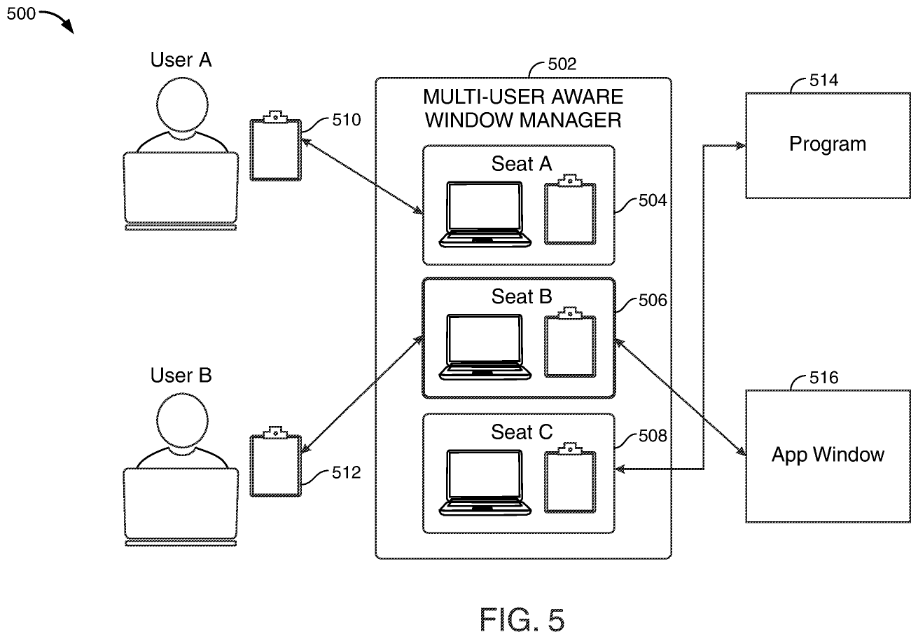

FIG. 5 shows diagram 500 of an illustrative secure, collaborative, digital clipboard system according to aspects of the disclosure. Components of the digital clipboard system shown in diagram 500 may substantially correspond to those shown diagram 400, aside from a few configuration choices. For example, diagram 500 includes a dedicated machine seat 508 that is mapped to program 514, providing a private copy/paste environment for programmatic access to the clipboard. Diagram 500 is also shown without a legacy system clipboard, presenting the possibility of the collaborative clipboard functioning in the place of, instead of in conjunction with, a legacy single-user system clipboard.

Configuration options shown and described may be made independently of each other. For example, in other embodiments, the system may interface with a single-user system clipboard and also include a separate machine seat, or may not include a separate machine seat and also not interface with a single-user system clipboard, and so on for other configuration options.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for a secure, collaborative, digital clipboard are provided. Persons skilled in the art will appreciate that the present invention can be practiced by other than the described embodiments, which are presented for purposes of illustration rather than of limitation, and that the present invention is limited only by the claims that follow.

1. A secure, collaborative, digital clipboard system, the system comprising computer executable code stored in a non-transitory memory that, when run on a processor, is configured to:
allocate two or more clipboard seats, wherein each clipboard seat is mapped to one of a plurality of user devices, wherein the user devices are each accessing a shared digital application in a collaborative digital workspace, wherein said collaborative digital workspace is configured to cause an action executed to the shared digital application on one of the user devices to generalize for all the user devices;
launch a shared digital clipboard;
assign an active state to one of the clipboard seats in response to a predetermined trigger event; and
execute copy and/or paste actions in the collaborative digital workspace exclusively for a user device mapped to the clipboard seat with the active state;
wherein the shared digital clipboard is configured to:
be used by each of the user devices to copy and paste information into each user device's mapped clipboard seat; and
maintain a private copy-and-paste environment for each of the clipboard seats, wherein information copied to a clipboard seat by a user device mapped to the clipboard seat is inaccessible to a user device that is not mapped to that clipboard seat.

2. The system of claim 1 further configured to allocate a plurality of clipboard seats corresponding to the plurality of user devices, wherein each of the clipboard seats is mapped to a corresponding one of the plurality of user devices.

3. The system of claim 2 wherein:
the shared digital application is a first shared digital application, the collaborative digital workspace is a first collaborative digital workspace, and the active state is a first active state;
the user devices are each also accessing a second shared digital application in a second collaborative digital workspace; and
the system is further configured to:
assign a second active state to another one of the clipboard seats in response to another predetermined trigger event; and
execute copy and paste actions in the second collaborative digital workspace exclusively for a user device mapped to the clipboard seat with the second active state.

4. The system of claim 1 further configured to allocate a machine clipboard seat, wherein the machine clipboard seat is a clipboard seat that:
is mapped to a computer program that is configured to access said shared digital clipboard without user intervention; and
provides a private copy-and-paste environment for the computer program.

5. The system of claim 1 further configured to:
receive copy and/or paste actions from a user device mapped to the clipboard seat with the active state;
translate the copy and/or paste actions into instructions for a single-user digital clipboard; and
transmit the instructions to a native single-user digital clipboard on two or more of the user devices to synchronize the native single-user digital clipboard with the shared digital clipboard.

6. The system of claim 5 wherein the native single-user digital clipboard is synchronized with the shared digital clipboard in response to a copy or paste action received from a user device mapped to the clipboard seat with the active state.

7. The system of claim 5 wherein the native single-user digital clipboard is continuously synchronized with the shared digital clipboard.

8. The system of claim 1 wherein the predetermined trigger event comprises an event that activates a focus of a window associated with the shared digital application and/or the collaborative digital workspace of a user device, and the clipboard seat mapped to said user device is assigned the active state.

9. The system of claim 1 wherein:
the predetermined trigger event comprises a detection of user activity associated with a user device, and the clipboard seat mapped to said user device is assigned the active state; and
the user activity is from a list that comprises mouse pointer events, keyboard events, and touchscreen events.

10. The system of claim 1 wherein:
the predetermined trigger event comprises a detection of a predetermined gesture performed by a user device, and the clipboard seat mapped to said user device is assigned the active state; and
the gesture is from a list that comprises cut gestures, copy gestures, and paste gestures.

11. A method for providing a secure, collaborative, digital clipboard, the method executed by computer executable code stored in a non-transitory memory and running on a processor, the method comprising:
allocating two or more clipboard seats, wherein each clipboard seat is mapped to one of a plurality of user devices, wherein the user devices are each accessing a shared digital application in a collaborative digital workspace, wherein said collaborative digital workspace is configured to cause an action executed to the shared digital application on one of the user devices to generalize for all the user devices;
launching a shared digital clipboard;
assigning an active state to one of the clipboard seats in response to a predetermined trigger event; and
executing copy and/or paste actions in the collaborative digital workspace exclusively for an entity a user device mapped to the clipboard seat with the active state wherein the shared digital clipboard is configured to:
be used by each of the user devices to copy and paste information into each user device's mapped clipboard seat; and
maintain a private copy-and-paste environment for each of the clipboard seats, wherein information copied to a clipboard seat by a user device mapped to the clipboard seat is inaccessible to a user device that is not mapped to that clipboard seat.

12. The method of claim 11 further comprising:
allocating a plurality of clipboard seats corresponding to the plurality of user devices; and
mapping each of the plurality of clipboard seats to a corresponding one of the plurality of user devices.

13. The method of claim 12 wherein:
the shared digital application is a first shared digital application, the collaborative digital workspace is a first collaborative digital workspace, and the active state is a first active state;
the user devices are each also accessing a second shared digital application in a second collaborative digital workspace; and
the method further comprises:
assigning a second active state to another one of the clipboard seats in response to another predetermined trigger event; and
executing copy and paste actions in the second collaborative digital workspace exclusively for a user device mapped to the clipboard seat with the second active state.

14. The method of claim 11 further comprising allocating a machine clipboard seat, wherein the machine clipboard seat is a clipboard seat that:
is mapped to a computer program that is configured to access said shared digital clipboard without user intervention; and
provides a private copy-and-paste environment for the computer program.

15. The method of claim 11 further comprising:
receiving copy and/or paste actions from a user device mapped to the clipboard seat with the active state;
translating the copy and/or paste actions into instructions for a single-user digital clipboard; and
transmitting the instructions to a native single-user digital clipboard on two or more of the user devices to synchronize the native single-user digital clipboard with the shared digital clipboard.

16. The method of claim 15 further comprising synchronizing the native single-user digital clipboard with the shared digital clipboard in response to a copy or paste action received from a user device mapped to the clipboard seat with the active state.

17. The method of claim 15 further comprising continuously synchronizing the native single-user digital clipboard with the shared digital clipboard.

18. The method of claim 11 wherein the predetermined trigger event comprises an event that activates a focus of a window associated with the shared digital application and/or the collaborative digital workspace of a user device, and the clipboard seat mapped to said user device is assigned the active state.

19. The method of claim 11 wherein:
the predetermined trigger event comprises a detection of user activity associated with a user device, and the clipboard seat mapped to said user device is assigned the active state; and
the user activity is from a list that comprises mouse pointer events, keyboard events, and touchscreen events.

20. The method of claim 11 wherein:
the predetermined trigger event comprises a detection of a predetermined gesture performed by a user device, and the clipboard seat mapped to said user device is assigned the active state; and
the gesture is from a list that comprises cut gestures, copy gestures, and paste gestures.
